(19) United States
(12) Patent Application Publication
(10) Pub. No.: US 2024/0309521 A1
(43) Pub. Date: Sep. 19, 2024

(54) ARRANGEMENT AND METHOD FOR ELECTROLYSIS POWER CONVERSION

(71) Applicant: CONVION OY, Espoo (FI)

(72) Inventor: Kim ÅSTRÖM, Kirkkonummi (FI)

(21) Appl. No.: 18/576,265

(22) PCT Filed: Jul. 21, 2021
(86) PCT No.: PCT/FI2021/050537

§ 371 Date: Jan. 3, 2024

(51) Int. Cl. C25B 9/65; C25B 9/70; H01M 8/04858; H01M 8/12; H02M 1/00; H02M 1/44; H02M 3/158

(52) U.S. Cl. CPC C25B 9/65; C25B 9/70; H01M 8/04888; H02M 1/0054; H02M 1/44; H02M 3/158; H01M 2008/1293

(57) ABSTRACT

A system for electrolysis power conversion includes electrolyser cells arranged as controllable series connected cell groups, a unit for electrolysis operation at a first voltage in the range of 1.0-2.5V per cell and a unit for at least intermittently drawing current from the cell groups at a second voltage at 0.4-1.0V per cell. The system includes at least one capacitor bank maintained at the first voltage and a capacitor bank maintained at the second voltage, the capacitor banks and cell groups having one pole in common and a bidirectional non-isolating DC/DC converter for connecting the first and second voltage capacitor banks. The system further includes a controller for the first and second voltages levels and a half-bridge switch pair for each controllable cell group for individually alternating between the first and second voltage levels being applied to the cell groups to prevent escalating unbalances and cell degradation.

### THE FIELD OF THE INVENTION

Most of the energy of the world is produced by means of oil, coal, natural gas or nuclear power. All these production methods have their specific problems as far as, for example, availability and friendliness to environment are concerned. As far as the environment is concerned, especially oil and coal cause pollution when they are combusted. The problem with nuclear power is, at least, storage of used fuel.

Especially because of the environmental problems, new energy sources, more environmentally friendly and, for example, having a better efficiency than the conventional energy sources, have been developed.

Solid oxide cells operate via a chemical reaction in an environmentally friendly process and are very promising future energy conversion devices. The intermittency of renewable energy sources has introduced challenges for the electrical grid stability, calling for increased demand and supply side flexibility and new energy storage and conversion technologies.

### THE STATE OF THE ART

An electrochemical active solid oxide cell can be used as a fuel cell or an electrolyser. A fuel cell produces electricity and heat from various fuels and an electrolysis cell produces chemicals such as hydrogen, methane, ammonia and carbon monoxide from steam, CO2, and nitrogen, electricity and heat. Such a cell that operates in both modes, as a fuel cell and electrolyser, is called a solid oxide electrochemical cell (SOEC) or reversible solid oxide cell (rSOC) or simply a solid oxide cell (SOC).

Solid oxide cell (SOC) comprises a fuel side and an oxygen rich side and an electrolyte material between them. In solid oxide fuel cells (SOFCs) oxygen is fed to the oxygen rich side and it is reduced to a negative oxygen ion. The negative oxygen ion goes through the electrolyte material to the fuel side where it reacts with fuel producing water and also typically carbon dioxide (CO2). Fuel side and oxygen rich side are connected through an external electric circuit comprising a load for the fuel cell operating mode withdrawing electrical energy out of the system. The fuel cells also produce heat to the reactant exhaust streams. In electrolysis operating mode, current flow is reversed and the solid oxide cells act as a load to which electricity is supplied. Depending on operating conditions, the cell operation can be endothermic, exothermic or thermoneutral.

Fuel cell reactions in the case of methane, carbon monoxide and hydrogen fuel are shown below:

Fuel side: CH₄+H₂O=CO+3H₂

CO+H₂O=CO₂+H₂

H₂+O²⁻=H₂O+2e⁻

Oxygen rich side: O₂+4e⁻=2O²⁻

Net reactions: CH₄+2O₂=CO₂+2H₂O

CO+1/2O₂=CO₂

H₂+1/2O₂=H₂O

In electrolysis operating mode (solid oxide electrolysis cells, (SOEC)) the reaction is reversed, i.e. electrical energy from a source is supplied to the cell where water and often also carbon dioxide are reduced in the fuel side forming oxygen ions, which move through the electrolyte material to the oxygen rich side where oxidation reaction takes place. It is possible to use the same solid oxide cell in both SOFC and SOEC modes.

Prior art solid oxide electrolyzer cells operate at temperatures which allow high temperature electrolysis reaction to take place, said temperatures being typically between 500-1000° C., but even over 1000° C. temperatures may be useful. These operating temperatures are similar to those conditions of the solid oxide fuel cells (SOFCs). The net cell reaction produces hydrogen and oxygen gases. The reactions for steam electrolysis are shown below:

Fuel side: H₂O+2e⁻--->2H₂+O²⁻

Oxygen rich side: O²⁻--->1/2O₂+2e⁻

Net Reaction: H₂O--->H₂+1/2O₂.

In case of co-electrolysis, a carbonaceous species is supplied to the cell in addition to steam, typically in proportions favorable for subsequent refining of the result gas according to e.g. the Fischer-Tropsch process. Carbon dioxide can be directly reduced to carbon monoxide or can interact with hydrogen through the water-gas shift reaction to form carbon monoxide and steam. It is also possible to use solid oxide cells for electrochecmical reduction of carbon dioxide to carbon monoxide according to the net reaction:

CO₂--->CO+½O2

In Solid Oxide Fuel Cell (SOFC) and Solid Oxide Electrolyzer (SOE) stacks where the flow direction of the fuel side gas are relative to the oxygen rich side gas internally in each cell as well as relative to the flow directions of the gases between adjacent cells, stacks are combined through different cell layers of the stack. Further, the fuel side gas or the oxygen rich side gas or both can pass through more than one cell before it is exhausted and a plurality of gas streams can be split or merged after passing a primary cell and before passing a secondary cell. These combinations serve to increase the current density and minimize the thermal gradients across the cells and the whole stack.

The high operating temperature in the SOC cells and system introduce material related challenges with respect to thermomechanical forces, material properties, chemical stability and uniformity of operating conditions. These aspects place practical constraints on feasible SOC cell, stack and module sizes. Scaling the technology for large installations, typical to SOEC application, will thus primarily rely on multiplication of cells, stacks and SOC modules. Minimizing the cost of each multiplying unit at all levels is thus crucial for reducing the overall cost.

A SOC module comprises tens up to hundreds of SOC stacks, support structures, thermal insulation, reactant conveying and distribution structures, instrumentation as well as electrical and reactant interfacing towards the application or other modules. As high temperature interfaces are costly, space-consuming and may constitute an ignition source, it is also beneficial to include heat exchanging within the module to lower the temperature of the reactant interfaces. Furthermore, the SOC module needs internal or external means to facilitate safe start-up and shutdown.

Industrial level electrolysis, reaching total power levels of tens of megawatts up to gigawatts are based on a very high number of individual electrolysis cells, built into stacks, groups of stacks and electrolysis modules, containing one or several groups of stacks. To drive the electrolysis reaction a DC or pulsed DC current needs to be supplied to the cells, whereas in fuel cell mode a current is drawn from the cells. A power electronic conversion is typically needed to interface the fuel cells with the power source or sink. This can be the AC distribution grid, or e.g. an industrial DC distribution system. The DC distribution for electrolysis can be energized from e.g. the AC distribution grid or in direct coupling to renewable sources such as photovoltaics, wind and wave power. Conversions between different voltages and/or frequencies requires power electronics equipment and introduce losses. These play a significant part in both the capital and operational expenditure relating to both electrolysis and fuel cell operation.

In high power applications, series connection of a large number of individual cells or groups of cells allows for reaching high string voltages. The number of cells can be optimized for a given interfacing voltage level or a given semiconductor voltage range. In case of reversible operation, the difference in string voltage between electrolysis and fuel cell operation will, however, be large. This may imply low utilization of power electronics circuitry in at least one of the modes.

Typically, the control target of power electronics is to manage the current of the cells as this determines the reactant or respectively fuel utilization, which is essential to manage from lifetime and gas composition point of view. The current can, however, also be controlled indirectly by controlling the cell voltage, as the cells have a fairly large DC series resistance. A special characteristic of high temperature cells is the strong temperature dependence of their internal, or area specific resistance (ASR). The temperature coefficient is negative, i.e. increasing temperature leads to lower resistance and hence, higher current at a given voltage. Thus, parallel connected cells or groups of cells exhibit a positive feedback behavior, i.e. tendency to diverge from an initially even distribution of currents among parallel paths. This can be counteracted by actively controlling the current of each branch or by active temperature management and/or thermal coupling of the parallel groups. Within a series connection, the current is the same for all series connected elements assuming absence of short-circuits over elements or other unintentional current paths. Control can be accomplished based on the current and total voltage of the series, but it may be advantageous to measure also voltages within the series for the purpose of operational constraints or safeguards.

A straight-forward approach to current management is to have a dedicated power converter for each parallel branch. It can be, for example a DC/DC converter interfacing a common DC-bus or an AC/DC converter interfacing the utility grid. In high power applications, non-isolating, typically hard-switching converter topologies are preferred due to cost and efficiency considerations. For DC/DC conversion typical topologies are buck, boost and buck-boost, whereas for AC/DC the three-phase active full-bridge is used. For low temperature electrolysis, also various passive 6-pulse or 12-pulse rectification are used, as well as thyristor-based bridge topologies, but these suffer from poor controllability, poor power factor and/or high amount of grid-frequency inductive components. For SOFC/SOEC applications, requiring more sophisticated control, the active topologies are preferred.

An industrial SOFC/SOEC high power module may have up to tens of cell series (strings). Equipping each string with a dedicated power converter enables maximum control flexibility but implies a high number of converters, discrete components and cost compared to a common converter solution. The difference can be reduced by minimizing the dedicated portion or power level. For example, instead of dedicated DC/DC converters converting the full power of a stack string, a lower-power uni- or bidirectional controllable power supply can be placed in series with each string, providing voltage offsetting at the level required to retain balance, typically few percent of the total voltage. All such series can then be connected in parallel to a common power stage. Thus, balancing can be achieved with a much lower power level and losses in the balancing function itself.

Electrical impedance spectroscopy is a widely used method to characterize fuel cells. From the spectrum of typical solid oxide cells can be seen that frequencies in the range of 1-10 Hz and below affect diffusion and concentration phenomena within the cell, whereas at higher frequencies the capacitive properties relating to different cell functional layers dominate. Based on impedance spectroscopy, an equivalent circuit representation of the solid oxide cell can be constructed. The equivalent circuit representations typically constitute a global series resistance element in series with a number of additional resistances with a paralleled capacitance, representing the different functional layers. A series inductance may also be included, particularly if the cabling to the cell is included. With pure DC-current only the resistive elements remain, their sum representing the total DC resistance of the cell. For both fuel cell and electrolysis operation, it is the DC-component of the current that gives rise to net conversion. Any alternating component on top of that would give rise to incremental losses in the resistive elements without contributing to the net reaction rate.

FIG. 1 presents an example of a prior art embodiment wherein each stack group 103 has its own non-isolated AC/DC converter. For simplicity, only one stack group is presented in FIG. 1. The same arrangement 115 is multiplied to all stack groups according to the prior art. Switch-mode power converters inherently cause ripple currents at their switching frequency, and in case of AC/DC conversion often also at twice the grid frequency. Much research has been placed in understanding the effects of ripple at various frequencies for solid oxide cells. Results on whether ripple current itself may have a lifetime degrading effect is not conclusive, but to one skilled in the art, the effect of increasing resistive losses is apparent from the equivalent circuit representation. As the fuel cell reaction in itself is exothermic, i.e. requiring removal of heat, it is apparent that additional heat generation is undesirable. In this respect, fuel cells, due to their high internal resistance compared to e.g. batteries, place more stringent requirements on ripple mitigation as means to improve efficiency and possibly also lifetime. Much research in the field of power electronics has been published in relation to topologies and strategies for ripple mitigation, with particular emphasis for low power fuel cell applications. Ripple mitigation also serves the purpose of minimizing electromagnetic interference, which is particularly restricted in residential applications.

For high temperature electrolysis, the reaction being endothermic, excess heat is required to maintain cell temperatures. Operating at a sufficiently high current density can provide this heat through the overpotentials (resistive loss elements in the equivalent circuit). The thermoneutral voltage, i.e. operating voltage at which resistive losses equal the required heat input, is approximately 1.3V. The current density required to achieve this voltage depends on the stack characteristics, temperature and other operating conditions. It may not, however, always be possible to operate at such high current density. Operating in an endothermic regime implies cooling of the cell unless external heat is supplied. Possibilities to supply heat through e.g. reactants or from the environment are limited and constitute extra cost for the system. Thus, utilizing the ability to increment the heat generation inside the cells through ripple injection can be a cost-effecting method to maintain thermoneutrality at low current densities. It is most beneficial to be able to control the amount of ripple on top of DC current that is supplied in order not to apply unnecessary ripple when additional heating is not desired. Therefore, pulsing at a lower frequency than the switching frequency is beneficial. With increasing pulsing frequencies, more switching losses will be generated in the power electronics, whereas their heating effect in the cells reduces, due to the capacitive elements in the equivalent circuit. Therefore, intentional heat generation through pulsing is most efficient at lower frequencies, the lower limit being when pulsing gives rise to adverse concentration overpotentials, i.e. below approximately 10 Hz. Optimum pulsing frequencies are thus likely found in the range between 10 Hz and 100 Hz, possibly up to 1 kHz. Such frequencies are approximately two orders of magnitude below typical switching frequencies, i.e. control-wise uncomplicated to accomplish. Alternating between thermoneutral voltage and open circuit voltage would make overall operation thermoneutral, whereas the average current is proportional to the duty cycle. The frequency can also be a function of operating current or temperature.

Thermal control and balancing of groups is accomplished based on information of operating temperatures in the stack(s). The operating temperature of cells, stacks and stack groups can be obtained by e.g. thermocouple measurements from within or outside the cells. It is, however, not practical to arrange extensive amounts of physical measurements and high temperature instrumentation also have reliability concerns. Temperature information can also be obtained by indirect means, based on e.g. currents, voltages and reactant flow and temperature information. Preferably, real-time dynamic thermodynamic modelling can be used as part of model-based system control of system conditions. The model can estimate the temperature profile over stacks or cell groups. Control code capable of running thermodynamic models in parallel with real-time system control can be implemented e.g. on an industrial PC. Current and voltage information can readily be obtained from power converters without intrusive measurements in the stack environment. Flow information can also to a large extent be based on thermodynamic modelling with minimum amount of physical sensors in the stack environment.

For solid oxide electrolysis it has been shown that alternating between electrolysis and fuel cell mode can have lifetime improving effects through e.g. suppression of oxygen pressure buildup and microstructural damage. Such regeneration can be applied in a number of ways. If the system is capable of reverse operation, it can periodically switch to fuel cell mode as required. It has been shown that alternation intervals in the range of multiple hours may be sufficient to achieve the regenerative effect. However, alternating between operating modes at a pace dictated by the internal regeneration needs may not align with the operating mode preferences of the application. In an application with multiple independent electrolyser modules, this drawback can be compensated by operating one module at a time in fuel cell mode, while maintaining the others in electrolysis. However, the ability for bidirectional operation adds cost and complexity on the level of each module.

In a system or module involving multiple stack groups with dedicated controllable power converters, arranged with a common fuel side recirculation loop, as can be beneficially achieved by ejector recirculation, e.g. one group at a time may be brought to fuel cell mode operation while others run electrolysis. Thus, the majority of current is driven in electrolysis direction and the system globally has a net production of fuel. The product fuel from the groups running in electrolysis is supplied through the recirculation as fuel to the group in fuel cell mode. Thus, the module or system as a whole would not need the additional complexity of reverse operation apart from bidirectional power-electronics. Switching between operation modes on the stack group level can be arbitrarily slow. However, the module product gas being a mixture of electrolyser and fuel cell mode product gases, would reduce the overall reactant utilization, i.e. require more feedstock (e.g. steam) and subsequent drying of the outlet gas. In co-electrolysis, the mixture of fuel cell mode and electrolysis mode product gases would also affect the product gas equilibrium.

If alternating between operation modes is done at switching speeds similar to those relevant for the previously described pulsed heat injection, similar benefits are achieved. Alternating at frequencies above the threshold for forming adverse concentration gradients but yet sufficiently low for achieving the regenerative effects, makes the alternation invisible to the flow control portion of the system. Thus, mode alternation can be achieved without reversible operation capabilities on the system level and without sacrificing the system reactant utilization or product gas equilibrium composition.

Obviously, mode alternation, regardless of the approach taken, has the effect of reducing overall electrolysis production at a given electrolysis current density. If semi-simultaneous electrolysis and fuel cell operation takes place, the portion of operation in fuel cell mode will consume fuel generated in the electrolysis mode. Typically, fuel cell mode current densities is half of the electrolysis current density. Thus, if e.g. 20% of operation is in fuel cell mode and 80% in electrolysis, operated with a rectangular waveform, the average production density is 80%-0.5*20%=70% compared to continuous electrolysis operation at the given current density. Respectively, if it is sufficient to operate 10% in fuel cell mode, the average production is 85%. Even in an application intended for continuous electrolysis, this loss of capacity may be justified if it radically counteracts degradation phenomena. This, in turn, can allow for respectively increasing the current density. As research indicates that even infrequent alternation between operating modes, in the order of hours, it may be sufficient to achieve the beneficial degradation cancelling effects, and an operation strategy can be to abandon the mode alteration pulsing during peak demand hours, and possibly compensate with a higher degree of regenerative (fuel cell) mode during off-peak hours.

A requirement of frequent transitions between electrolysis and fuel cell operation places constraints on the power conversion. Switching between the modes implies frequent voltage cycling between approximately 50%-100% of the electrolysis voltage, which is problematic particularly for large capacitors. Individual buck or boost converters for each stack group can be configured to handle such transients, however at the expense of requiring a pair of switch semiconductors and dedicated full-current inductor and possible further high frequency ripple filter elements for each controllable group. Furthermore, all switches need to be dimensioned for the full electrolysis voltage.

### SHORT DESCRIPTION OF THE INVENTION

The object of the present invention is to achieve an advanced system for electrolysis power conversion with reduced size and conduction losses and increased lifetime. This is achieved by a system for electrolysis power conversion, the system comprising electrolyser cells arranged as controllable series connected cell groups, means for electrolysis operation at a first voltage in the range of 1.0-2.5V per cell and means for at least intermittently drawing current from the cell groups at a second voltage in the range of 0.4-1.0V per cell. The system comprises at least one capacitor bank maintained at the first voltage and at least one other capacitor bank maintained at the second voltage, the capacitor banks and cell groups having one pole in common, at least one bidirectional non-isolating DC/DC converter for connecting the first and second voltage capacitor banks, means for controlling the first and second voltages levels and at least one half-bridge switch pair for each controllable cell group for individually alternating between the first and second voltage levels being applied to the cell groups to prevent escalating unbalances and cell degradation.

The focus of the invention is also a method of electrolysis power conversion, wherein the method electrolyser cells are arranged as controllable series connected cell groups, electrolysis operation is performed at a first voltage in the range of 1.0-2.5V per cell and current is intermittently drawn from the cell groups at a second voltage in the range of 0.4-1.0V per cell. In the method at least one capacitor bank is maintained at the first voltage and at least one capacitor bank is maintained at the second voltage, the capacitor banks and cell groups having one pole in common, and at least one bidirectional non-isolating DC/DC converter is connected to the first and second voltage capacitor banks, and in the method is controlled the first and second voltages levels for individually alternating between the first and second voltage levels being applied to the cell groups to prevent escalating unbalances and cell degradation.

The invention is based on use of at least one capacitor bank maintained at the first voltage and at least one other capacitor bank maintained at the second voltage, said capacitor banks having one pole in common with cell groups. The invention is further based on at least one bidirectional non-isolating DC/DC converter for connecting the first and second voltage capacitor banks and means for controlling the first and second voltages levels and at least one half-bridge switch pair for each controllable cell group for individually alternating between the first and second voltage levels being applied to the cell groups.

The benefit of the invention is that a single DC/DC converter can serve multiple groups, thus reducing size and cost of the system. Also, conduction losses and electromagnetic interference can be minimized.

### SHORT DESCRIPTION OF FIGURES

FIG. 1 presents an example of a prior art embodiment wherein each stack group has its own non-isolated AC/DC converter.

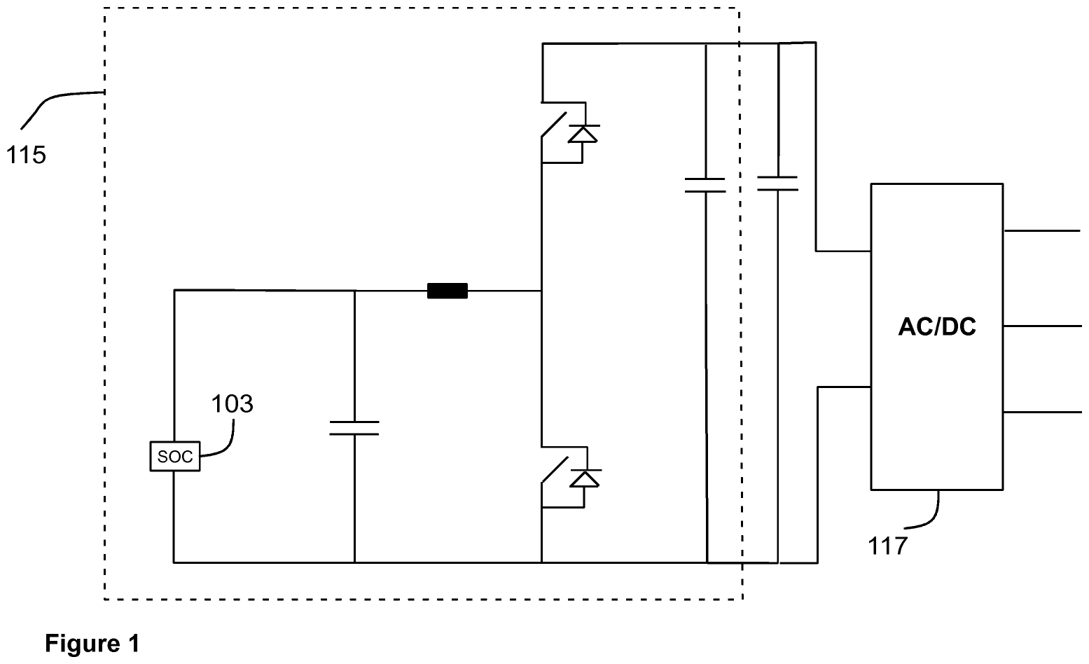

FIG. 2 presents an exemplary system for electrolysis power conversion according to the present invention.

FIG. 3 presents an exemplary circuitry according to the present invention.

FIG. 4 presents control means according to the present invention.

FIG. 5 presents exemplary current diagram of phase shifting of pulsing between cell groups with respect to a fluctuation waveform.

FIG. 6 presents exemplary voltage waves of phase shifting of pulsing between cell groups with respect to a fluctuation waveform.

### DETAILED DESCRIPTION OF THE INVENTION

The system according to the present invention comprises at least two capacitor banks for alternating between the two distinct voltage levels. A capacitor bank may consist of a single high voltage discrete capacitor, or multiple capacitors in parallel and/or in series. The two capacitor banks have one pole in common and they are connected by a bidirectional non-isolating DC/DC converter. The high and low voltage capacitor banks are common to all cell groups. Their common pole is also common to all individual fuel cell groups. In the following explanation and referred figure, the negative pole has been chosen to be common, but the topology can also be reversed to have the common rail on the positive side.

Individual control of each group is accomplished with a half-bridge switch pair between the high and low voltage capacitor voltages. The high side switch connects the cell group to the high voltage capacitor, whereas the low side switch connects it to the low voltage capacitor. The high voltage capacitor bank is controlled to an electrolysis voltage whereas the low voltage capacitor is controlled to the fuel cell mode voltage. In a preferable embodiment, the fuel cell group consists of approximately 750 cells in series, whereby operation at a voltage of 1.3-1.4V per cell in electrolysis modes yields a DC-link voltage of 975-1100V, whereas fuel cell operation in the range of 0.7-0.85V yields a low side capacitor voltage of 525-640V. The said high side voltage is optimal for active rectification from a 690V AC-source. The cell count or rectification source voltage can be optimized for a given topology at the feeding stage of the high side capacitor.

By changing the fuel cell group specific half-bridge switch states, the group can be altered between electrolysis, open circuit and fuel cell operation without need for dedicated inductive elements. Switching can take place at low frequencies e.g. 10-100 Hz, minimizing switching losses. A further benefit of the topology is that the cell group specific half-bridge only experiences the voltage difference between the high and low side capacitors. With the example voltages above, this yields a maximum voltage difference of 575V. This allows for using lower voltage gear in the group specific switches, further reducing size, cost and conduction losses.

The DC/DC converter interfacing the low voltage capacitor with the high voltage capacitor is responsible for recirculating the power drawn during the fuel cell mode pulses back to the high side capacitor bank. Its power level and thus switch and inductor sizing is remarkably low compared to the electrolysis power delivery. For example, for a fuel cell mode proportion of 20% with a current density half of the electrolysis and approximately half the voltage, the average current is approximately 10% and average power only 5% of the electrolysis power. Moreover, the duty near 50% for the DC/DC conversion is favorable for inductor sizing. By interleaving the pulses of different cell groups, the DC/DC can concurrently serve all groups, yet retaining its very low power dimensioning. This DC/DC converter can be a discrete converter, or e.g. one leg in a four-leg inverter. The low voltage capacitor can be a discrete capacitance or a subset of the high voltage capacitor, as explained later on.

In all operating modes involving rapid pulsing between electrolysis, open circuit and/or fuel cell operation modes, the duty of the respective modes can be used to control the thermal balance of individual cell groups. Electrolysis operation is, depending on the voltage, thermoneutral, -negative or positive. Open circuit is thermoneutral whereas fuel cell mode is always in itself thermopositive. The reactant flows also affect the thermal balance, typically causing net heat removal, as do thermal losses to the environment. By slightly adjusting e.g. the duty proportion of the fuel cell mode of individual groups, cell groups can be kept thermally in balance. An additional mechanism can be employed on top of this. An intentional fluctuation of the high and/or low side capacitor voltages can be introduced at the frequency of switching. The fluctuation can be e.g. 1-10% of the average voltage. The fluctuation waveform can be sinusoidal, triangular or rectangular. The low side voltage is beneficially fluctuated in phase with the high side voltage. As cell groups alternate between electrolysis and fuel cell mode (or open circuit) in an interleaved manner, the timing of the pulses with respect to the voltage fluctuation gives rise to different average voltage for different groups. A cell group hotter than average is set to have its fuel cell mode pulse during the top of the fluctuation, whereby it has lowest average voltage in electrolysis and highest in fuel cell mode, minimizing current flow in both modes. The coldest or lowest performing group is set to opposite phase, i.e. is connected to the low side voltage at the bottom of the waveform, thus maximizing the current. Thus, difference in average voltage in the order of few percent for different groups can be achieved, typically sufficient to counteract unbalances.

The amount of voltage fluctuation can be adjusted according to the balancing need. The interleaving of different cell groups can be dynamically adjusted to alternate which groups receive highest or lowest voltages according to the balancing needs. The synchronization between switching devices can be accomplished through an external synchronization signal, internal phase or external phase locked loop. The fluctuation (and hence pulsing) frequency can equal to the grid AC frequency or twice the frequency. Such a fluctuation in the capacitor voltage can readily be obtained by controlling three phase current with slight phase unbalance. With multiple paralleled systems applying the unbalance on different phases, overall unbalance will cancel out. Alternatively, the frequency can be an uneven multiplier of grid frequencies, e.g. 36 Hz for a 50 Hz grid, whereby fluctuation will be out of phase with the grid and not appear as harmonics. Multiple parallel systems may use slightly offsetted frequencies whereby they will cancel out on the grid level.

Altogether, the topology allows for customizable switching between fuel cell and electrolysis mode with reduced switching losses and minimized amount and size of inductive components. A prerequisite for eliminating fuel cell group specific inductors is that the high side capacitor voltage can be adjusted for the operation needs. In such case, the electrolysis can take place at a desired voltage and thus also at a desired current without need for inductors and high frequency switching. Small adjustments to group specific voltages and currents are yet possible with the aforementioned methods. The inherent inductance in the cell groups and related cabling limit the inrush currents at time of switching. In case of more limited flexibility on the high side voltage or desire to minimize said inrush currents, the amount of high frequency switches and groups specific inductors or LC-filters can be reduced. The two-level capacitor arrangement still provides benefits. The lower voltage difference over the half-bridge switches reduces ripple on the inductor, allowing to reduce its size by more than half.

If the high side voltage is higher than the electrolysis voltage, buck-operation of half-bridge will cause power draw from the low side capacitance during electrolysis operation. If for example, the high side capacitor voltage is equivalent to 1.4V per cell, electrolysis operation voltage is 1.3V and the low side voltage is 0.7V per cell, current will be drawn from the high side and low side in the inverted proportions to voltage differences i.e. 0.1V:0.6V between the low side and high side. With these example voltages, 14% of the electrolysis current would be drawn from the low side capacitance. By choice of voltages this portion can be adjusted between 0% and e.g. 20%. With alternation between electrolysis and fuel cell operation, the current flow into the low side capacitance during fuel cell mode counteracts the power draw during electrolysis mode. In the earlier indicated example, this average current was in the range of 10% of the average electrolysis current. With proper choice of voltages, the opposite directed current flows during electrolysis and fuel cell mode can cancel out, eliminating the need for power flow through the DC/DC converter interfacing the low voltage capacitor and high voltage capacitor. With proper control strategies, this separate DC/DC converter can be completely eliminated. Start-up charging of the low side capacitor can be accomplished in parallel with the high side voltage charging through the half-bridge switches and thereafter maintained at the desired level through a combination of active control and passive means.

In one preferable embodiment, the high side and low side capacitances are partially combined such that the high side capacitance consists of at least two series connected capacitors or capacitor banks, out of which the low side capacitor is a subset. In the above presented example, the low side voltage was exactly half of the high side, i.e. suitable as the middle point of a series of two equal capacitances. As the current flow and hence voltage of this middle point is controlled, the voltage can be offsetted from the middle point within the allowable range for capacitor voltages. High voltage capacitor banks consisting of multiple series connected banks can be readily found in standard inverter equipment.

In a system configured for truly bidirectional operation, i.e. persistent as opposed to intermittently pulsed operation in fuel cell mode, the capacitor bank interfacing DC/DC converter needs to be dimensioned for continuous fuel cell current, unless the high side voltage can be lowered to the fuel cell level. Yet, the power level of this DC/DC converter and related inductor is only in the order of 25% of the electrolysis power due to lower current density and approximately half voltage. The benefit of the topology is that a single DC/DC can serve multiple groups, whilst the capability to prevent the groups from running into current sharing unbalance can be accomplished by intermittently turning off groups that otherwise would have a too high share of the current. Since difference between groups are small, off-pulses of few percent duty for highest performing groups shall be enough to prevent escalating unbalance. An optimal pulsing frequency is again in the 10 Hz-100 Hz range whereby switching losses and electromagnetic interference are minimized.

A further benefit of the topology is that the capacitor bank interfacing DC/DC converter can accomplish electronic oxidation protection of the fuel cells during process anomalies and/or flow interruptions. An inherent feature of the cell group specific half bridges is that their diodes will allow current flow from the low side capacitance into the fuel cell groups if fuel cell voltages drop below the low side capacitor voltage. To prevent oxidation, the cell voltage should be retained in the range of 0.8-1.0V per cell. Thus, to accomplish protection, it is sufficient to safeguard that the capacitor bank maintains this voltage during process anomalies. This can be accomplished with the said DC/DC as such, given that the high side voltage remains available. In addition, there can be a redundant feed, sourcing energy from e.g. a battery bank. The battery bank can be in direct connection to the capacitor or the supply or can be rectified from a safeguarded AC source. Since the power level is low, the redundant supply can be arranged in multiple cost-effective ways. The ability to provide said protection with main converters in passive state provides robustness against failures in the power stages. Means to disconnect the fuel cell circuitry from the high side voltage circuit can be needed to prevent simultaneous energization and undesired current flow other than to the fuel cells.

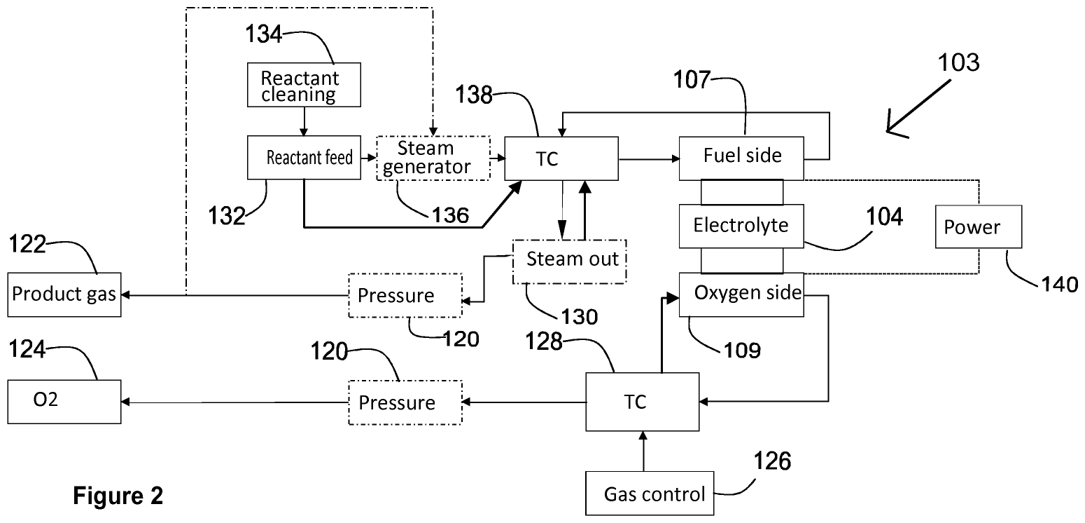

In FIG. 2 is presented an exemplary system for electrolysis power conversion according to the present invention. Power unit 140 provides electricity to the stack 103. Gas (e.g. air, oxygen O2, carbon dioxide CO2, nitrogen N2) is fed from the gas control unit 126 through the temperature control 128 to an oxygen side 109. Reactant (i.e. water H2O, carbon dioxide CO2, syngas) feed control 132 receives water or mixture of water and carbon dioxide from reactant cleaning unit 134 and feeds the steam generator 136 for generating steam. The generated steam is fed through a temperature control unit 138 to a fuel side 107. Electrolyte side 104 is located between the fuel side 107 and the oxygen side 109. From the reactant feed control unit 132 can also be a route directly to the temperature control unit 138 for carbon content of the co-electrolysis.

From the fuel side is performed steam circulation through the temperature control unit 138 and further to a product gas outlet 122 through a possible pressure control unit 120. The product gas is e.g. hydrogen H2, ammonia, methane and/or carbon monoxide. In one embodiment steam can also be recirculated to the reactant feed control unit 132 or to the steam generator 136. Steam can be let out from the steam out unit 130. From the steam out unit 130 can be a route also to the temperature control unit 138 for the ejector recirculation function. From the oxygen side 109 oxygen is fed through the temperature control unit 128 to the oxygen outlet 124 through a possible pressure control unit 120.

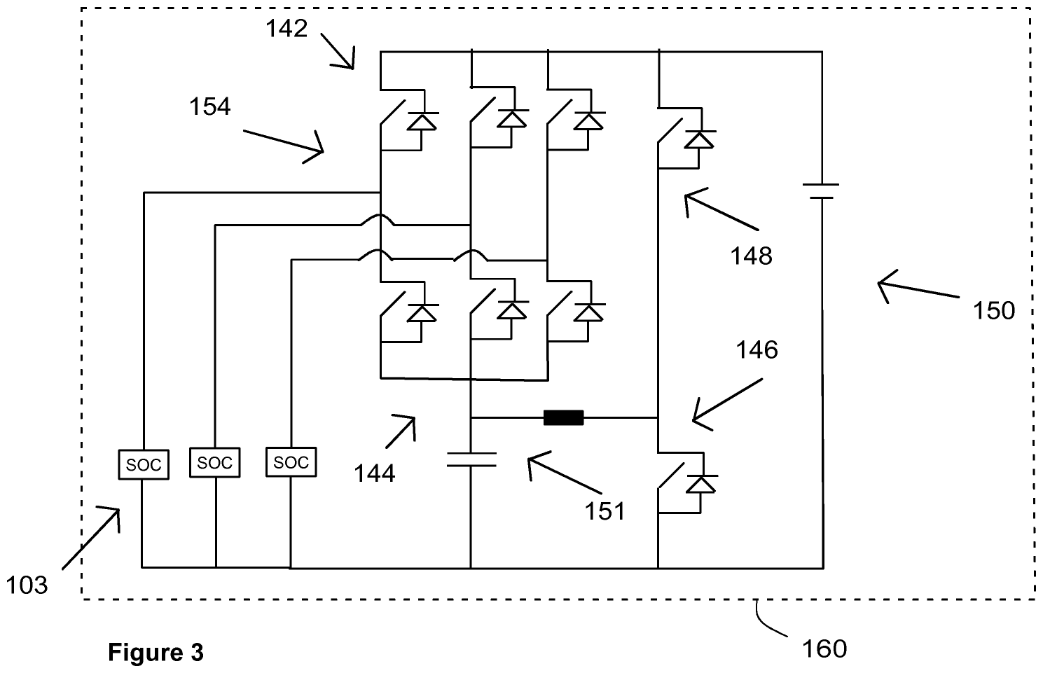

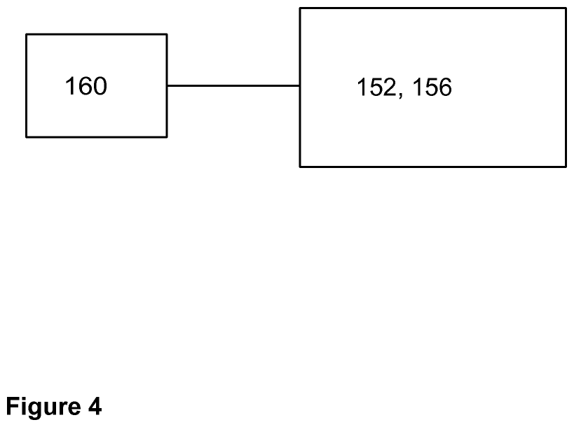

In FIG. 3 is presented an exemplary circuitry according to the system of the present invention. The system comprises electrolyser cells arranged as controllable series 103 connected cell groups and means 142 for electrolysis operation at a first voltage in the range of 1.0-2.5V per cell. Means 144 draw current at least intermittently from the cell groups at a second voltage in the range of 0.4-1.0V per cell. The system comprises at least one capacitor bank 1 150 maintained at the first voltage and at least one other capacitor bank 151 maintained at the second voltage. The capacitor banks and cell groups have one pole in common. In one embodiment the system can comprise high voltage capacitance bank and low voltage capacitance bank as partially combined such that the high voltage capacitance bank comprises at least two series connected capacitor banks, out of which the low side capacitor bank is a subset. At least one bidirectional non-isolating DC/DC converter 146-148 connects the first and second voltage capacitor banks. The system further comprises means for controlling the first and second voltages levels and at least one half-bridge switch pair for each controllable cell group for individually alternating between the first and second voltage levels which are applied to the cell groups to prevent escalating unbalances and cell degradation. In one embodiment the system can comprise means for generating a synchronization signal and at least one phase locked loop to accomplish synchronization between the half bridge switches. The system can also comprise means 156 (FIG. 4) for generating a synchronization signal and at least one phase locked loop to accomplish synchronization between the half bridge switches.

The presented first and second voltage ranges are determined to cover also low temperature electrolysis. The first voltage range may extend up to 2.5V per cell for PEM and alkaline electrolysis applications and the second voltage range may extend from 0.4 to 1.0V. For high temperature applications these voltage ranges can be narrower, e.g. the first voltage in the range of 1.2-1.5V and the second voltage in the range of 0.6-0.9V.

In FIG. 4 is presented schematic figure of the control means 152, 156 according to the present invention. The control means are microprocessor based and controlled on basis of measurement results (e.g. flow rate, flow amount, temperature, voltage, current etc.) to direct the operation of the exemplary circuitry 160 presented in FIG. 3.

In one preferred embodiment the means 152 for controlling are configured to alternate the cell groups between the first and second voltage levels in the 10 Hz-100 Hz frequency range to minimize switching losses and electromagnetic interference. The means 152 for controlling can be configured to pulse the cell groups between electrolysis cell voltage, fuel cell voltage and open circuit. The half-bridge switches 154 (FIG. 3) can be controlled to operate as non-isolating DC/DC converters 150 at a switching frequency at least one decade higher than the frequency of the alternation between the first and second voltage levels. One definition to the first voltage can be that it is above 800V and the second voltage can be below 800V.

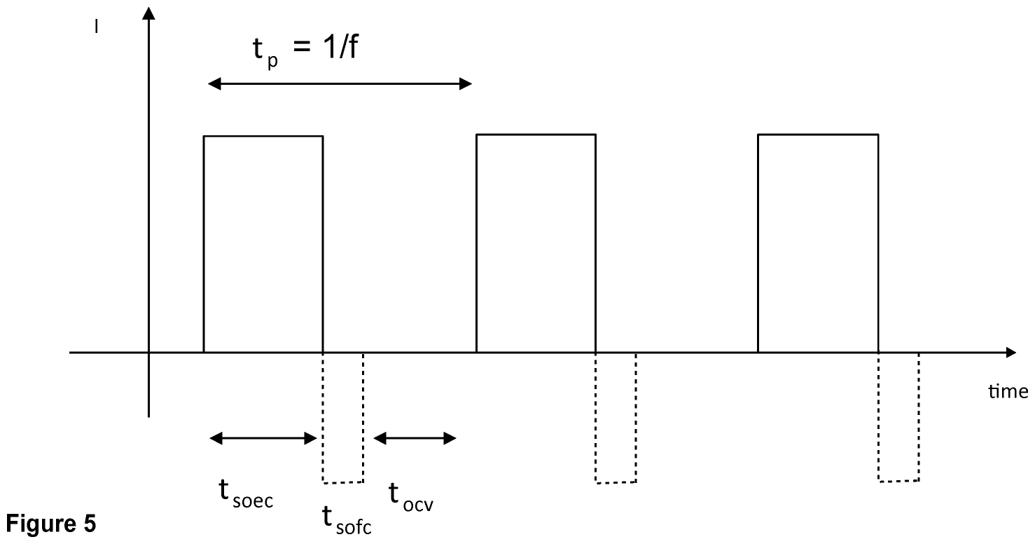

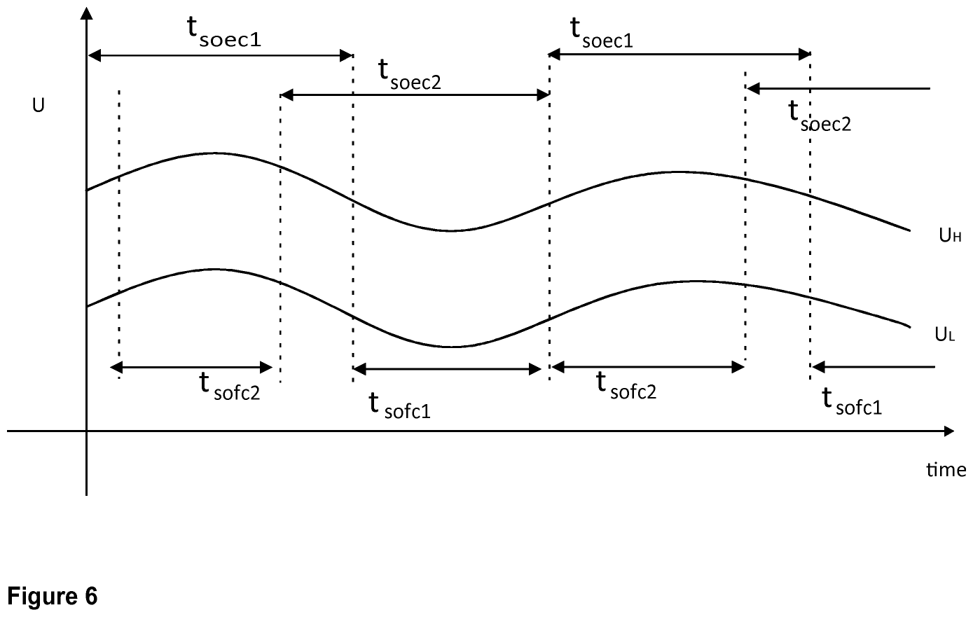

In one preferred embodiment, the means for controlling the voltage levels are configured to provide a controlled voltage fluctuation around the average to at least one of the capacitor banks. The fluctuation frequency can be equal to the cell group pulsing frequency, whereby phase shifting (t soec, t sofc, t ocv (open cell voltage)) of the pulsing between the cell groups with respect to the fluctuation waveform provides different average voltage to the individual cell groups. The current diagram is presented in an exemplary FIG. 5, and an exemplary FIG. 6 presents the voltage waves (UL, UH).

In one embodiment the means for controlling can be configured to alternate by providing voltages to eliminate opposite directed current flows during electrolysis and fuel cell mode in the cell groups in the capacitor bank configured for the second voltage level.

1. A system for electrolysis power conversion, the system comprising electrolyser cells arranged as controllable series connected cell groups, means for electrolysis operation at a first voltage in the range of 1.0-2.5V per cell and means for at least intermittently drawing current from the cell groups at a second voltage in the range of 0.4-1.0V per cell wherein the system comprises at least one capacitor bank maintained at the first voltage and at least one capacitor bank maintained at the second voltage, the capacitor banks and cell groups having one pole in common, at least one bidirectional non-isolating DC/DC converter for connecting the first and second voltage capacitor banks, means for controlling the first and second voltages levels and at least one half-bridge switch pair for each controllable cell group for individually alternating between the first and second voltage levels being applied to the cell groups to prevent escalating unbalances and cell degradation.

2. The system for electrolysis power conversion in accordance with claim 1, wherein the means for controlling are configured to alternate the cell groups between the first and second voltage levels in the 10 Hz-100 Hz frequency range to minimize switching losses and electromagnetic interference.

3. The system for electrolysis power conversion in accordance with claim 1, wherein the half-bridge switches are controlled to operate as non-isolating DC/DC converters at a switching frequency at least one decade higher than the frequency of the alternation between the first and second voltage levels.

4. The system for electrolysis power conversion in accordance with claim 1, wherein the first voltage is above 800V and the second voltage is below 800V.

5. The system for electrolysis power conversion in accordance with claim 1, wherein the means for controlling are configured to pulse the cell groups between electrolysis cell voltage, fuel cell voltage and open circuit.

6. The system for electrolysis power conversion in accordance with claim 1, wherein the means for controlling the voltage levels are configured to provide a controlled voltage fluctuation around the average to at least one of the capacitor banks, the fluctuation frequency being equal to the cell group pulsing frequency, whereby phase shifting of the pulsing between the cell groups with respect to the fluctuation waveform provides different average voltage to the individual cell groups.

7. The system for electrolysis power conversion in accordance with claim 5, wherein the means for controlling are configured to alternate by providing voltages to eliminate opposite directed current flows during electrolysis and fuel cell mode in the cell groups in the capacitor bank configured for the second voltage level.

8. The system for electrolysis power conversion in accordance with claim 1, further comprising means for generating a synchronization signal and at least one phase locked loop to accomplish synchronization between the half bridge switches.

9. The system for electrolysis power conversion in accordance with claim 1, further comprising high voltage capacitance bank and low voltage capacitance bank as partially combined such that the high voltage capacitance bank comprises at least two series connected capacitor banks, out of which the low voltage capacitor bank is a subset.

10. A method of electrolysis power conversion, wherein electrolyser cells are arranged as controllable series connected cell groups, the method comprising:
performing electrolysis operation at a first voltage in the range of 1.0-2.5V per cell, and
intermittently drawing current from the cell groups at a second voltage in the range of 0.4-1.0V per cell,
wherein in the method at least one capacitor bank is maintained at the first voltage and at least one capacitor bank is maintained at the second voltage, the capacitor banks and cell groups having one pole in common, and at least one bidirectional non-isolating DC/DC converter is connected to the first and second voltage capacitor banks, and in the method is controlled the first and second voltages levels for individually alternating between the first and second voltage levels being applied to the cell groups to prevent escalating unbalances and cell degradation.

11. The method of electrolysis power conversion in accordance with claim 10,
further comprising alternating the cell groups between the first and second voltage levels in the 10 Hz-100 Hz frequency range to minimize switching losses and electromagnetic interference.

12. The method of electrolysis power conversion in accordance with claim 10, wherein half-bridge switches are controlled to operate as non-isolating DC/DC converters at a switching frequency at least one decade higher than the frequency of the alternation between the first and second voltage levels.

13. The method of electrolysis power conversion in accordance with claim 10, wherein the first voltage is above 800V and the second voltage is below 800V.

14. The method of electrolysis power conversion in accordance with claim 10, further comprising pulsing the cell groups between electrolysis cell voltage, fuel cell voltage and open circuit.

15. The method of electrolysis power conversion in accordance with claim 10, further comprising providing a controlled voltage fluctuation around the average to at least one of the capacitor banks, the fluctuation frequency being equal to the cell group pulsing frequency, whereby phase shifting of the pulsing between the cell groups with respect to the fluctuation waveform provides different average voltage to the individual cell groups.

16. The method of electrolysis power conversion in accordance with claim 15, wherein the method is alternated by providing voltages to eliminate opposite directed current flows during electrolysis and fuel cell mode in the cell groups in the capacitor bank configured for the second voltage level.

17. The method of electrolysis power conversion in accordance with claim 10, further comprising generating a synchronization signal and at least one phase locked loop to accomplish synchronization between the half bridge switches.

18. The method of electrolysis power conversion in accordance with claim 10, further comprising partially combining high voltage capacitance bank and low voltage capacitance bank such that the high voltage capacitance bank comprises at least two series connected capacitor banks, out of which the low voltage capacitor bank is a subset.
